(19) United States
(12) Patent Application Publication
(10) Pub. No.: US 2014/0346701 A1
(43) Pub. Date: Nov. 27, 2014

(54) PATTERN FORMATION DEVICE, METHOD FOR PATTERN FORMATION, AND PROGRAM FOR PATTERN FORMATION

(71) Applicant: Kabushiki Kaisha Toshiba, Tokyo (JP)

(72) Inventors: Sachiko KOBAYASHI, Chiba-ken (JP); Kazuhiro TAKAHATA, Kanagawa-ken (JP); Yingkang ZHANG, Kanagawa-ken (JP); Masafumi ASANO, Kanagawa-ken (JP); Shigeki NOJIMA, Kanagawa-ken (JP)

(21) Appl. No.: 14/454,955

(22) Filed: Aug. 8, 2014

Related U.S. Application Data
(62) Division of application No. 13/424,427, filed on Mar. 20, 2012.

(30) Foreign Application Priority Data
Sep. 21, 2011 (JP) 2011-206390

(51) Int. Cl. B29C 59/02; B29C 59/00; B29C 71/04

(52) U.S. Cl. CPC B29C 59/026; B29C 71/04; B29C 59/002; B29K 2105/246
USPC 264/40.5

(57) ABSTRACT

According to one embodiment, a pattern formation device that presses a template that includes a concave and convex part onto a transferring object and that forms a pattern in which a shape of the concave and convex part is transferred is provided. The device includes: a calculation part; an adjustment part; and a transfer. The calculation part calculates, using design information of the pattern, the distribution of force applied to the pattern at a time of releasing the template pressed onto the transferring object from the transferring object. The adjustment part adjusts forming conditions of the pattern in order to uniformly approach the distribution of force calculated by the calculation part. The transfer part transfers the shape of the concave and convex part to the transferring object according to the forming conditions adjusted by the adjustment part.

### CROSS-REFERENCE TO RELATED APPLICATIONS

This application is based upon and claims the benefit of priority from the prior Japanese Patent Application No. 2011-206390, filed on Sep. 21, 2011; the entire contents of which are incorporated herein by reference.

### FIELD

Embodiments described herein relate generally to a pattern formation device, a method for pattern formation, and a program for pattern formation.

### BACKGROUND

In a so-called imprint method where a template having a concave and convex pattern formed thereon is used to transfer a pattern, the template is contacted with resin dripped onto a substrate, and the resin is cured in this state by irradiating with an ultraviolet light or the like. Thereafter, by releasing the template, the shape of the concave and convex pattern of the template is transferred to the resin.

Repeated use of the same template allows manufacturing processes to be simplified and manufacturing costs to be reduced in the formation of patterns where a template is used.

Further improvements of yield are desired in this type of formation of patterns where a template is used.

### BRIEF DESCRIPTION OF THE DRAWINGS

FIG. 1 is a block diagram illustrating an example of a configuration of a pattern formation device according to a first embodiment;

FIGS. 2A to 2D are schematic views illustrating an outline of a procedure for pattern formation;

FIG. 3 is a flowchart illustrating an example of a method for pattern formation according to an embodiment;

FIGS. 4A to 4E are schematic illustrations to describe the processes from the calculation of the distribution of force to the adjustment;

FIG. 5 is a block diagram illustrating an example of a configuration of a pattern formation device according to a second embodiment;

FIG. 6 is a flowchart illustrating an example of a method for pattern formation according to an embodiment;

FIG. 7 is a flowchart illustrating another example of a method for pattern formation according to an embodiment;

FIG. 8 is a flowchart illustrating an example of a method for pattern formation according to a third embodiment;

FIGS. 9A to 9D are schematic views illustrating examples of where the position of a pattern block is modified;

FIGS. 10A to 10F are schematic plan views illustrating examples of pattern correction;

FIG. 11 is a flowchart illustrating an example of a method for pattern formation according to a fourth embodiment;

FIGS. 12A and 12B are illustrations to explain a computer on which the program according to the embodiment is executed; and

FIG. 13 is a flowchart illustrating an example of a process flow of the program according to the embodiment.

### DETAILED DESCRIPTION

In general, according to one embodiment, a pattern formation device that presses a template that includes a concave and convex part onto a transferring object and that forms a pattern in which a shape of the concave and convex part is transferred is provided. The device includes: a calculation part; an adjustment part; and a transfer. The calculation part calculates, using design information of the pattern, the distribution of force applied to the pattern at a time of releasing the template pressed onto the transferring object from the transferring object. The adjustment part adjusts forming conditions of the pattern in order to uniformly approach the distribution of force calculated by the calculation part. The transfer part transfers the shape of the concave and convex part to the transferring object according to the forming conditions adjusted by the adjustment part.

In general, according to another embodiment, a method for pattern formation that presses a template that includes a concave and convex part onto a transferring object and that forms a pattern in which a shape of the concave and convex part is transferred is provided. The method includes: calculating, using design information of the pattern, a distribution of force applied to the pattern at a time of releasing the template pressed onto the transferring object from the transferring object; adjusting forming conditions of the pattern in order to uniformly approach the distribution of force; and transferring the shape of the concave and convex part to the transferring object according to the forming conditions after the adjusting.

In general, according to another embodiment, a method for pattern formation that presses a template that includes a concave and convex part onto a transferring object and that forms a pattern in which a shape of the concave and convex part is transferred is provided. The method includes: calculating, using design information of the pattern, a distribution of force applied to the pattern at a time of releasing the template pressed onto the transferring object from the transferring object; modifying the design information according to the distribution of force; and transferring the shape of the concave and convex part to the transferring object according to the modified design information.

In general, according to another embodiment, a program for pattern formation that presses a template that includes a concave and convex part onto a transferring object and that forms a pattern in which the shape of the concave and convex part is transferred is provided. The program includes: a computer that functions as: calculation unit that calculates, using design information of the pattern, a distribution of force applied to the pattern at a time of releasing the template pressed onto the transferring object from the transferring object; adjustment unit that adjusts forming conditions of the pattern in order to uniformly approach the distribution of force; and output unit that outputs the forming conditions after the adjusting.

Embodiments of the invention will now be described with reference to the drawings.

Note that the drawings are schematic or simplified illustrations and that relationships between thicknesses and widths of parts and proportions in size between parts may differ from actual parts. Also, even where identical parts are depicted, mutual dimensions and proportions may be illustrated differently depending on the drawing.

Note that in the drawings and specification of this application, the same numerals are applied to constituents that have already appeared in the drawings and have been described, and repetitious detailed descriptions of such constituents are omitted.

### First Embodiment

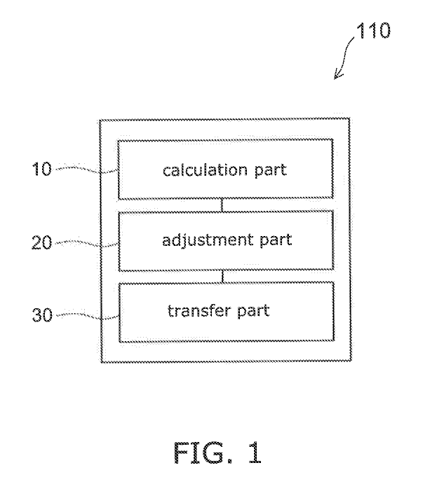

FIG. 1 is a block diagram illustrating an example of a configuration of a pattern formation device according to the first embodiment.

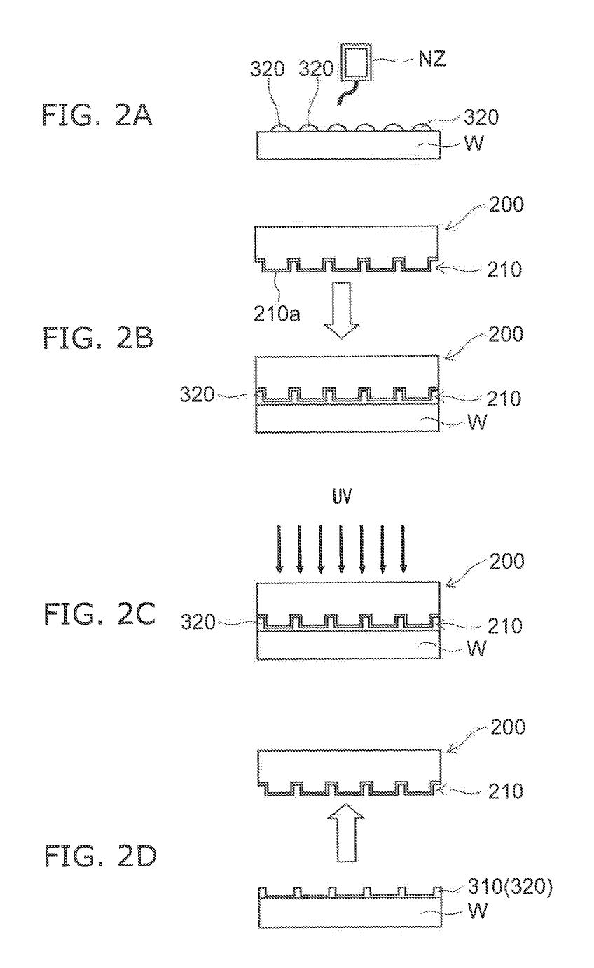

FIGS. 2A to 2D are schematic views illustrating an outline of a procedure for pattern formation.

As illustrated in FIG. 1, a pattern formation device 110 according to the embodiment is provided with a calculation part 10, an adjustment part 20, and a transfer part 30.

The transfer part 30 of the pattern formation device 110 forms a pattern 310 according to the procedure illustrated in FIGS. 2A to 2D.

First, as illustrated in FIG. 2A, a resin 320, as one example of a transferring object, is applied on a substrate W. The resin 320 is an ultraviolet curable resin that cures by irradiating a beam of ultraviolet light or the like. The resin 320 is applied in a pre-cured state. The resin 320 may be discharged onto the substrate W by, for example, a nozzle NZ.

Next, as illustrated in FIG. 2B, the shape of a concave and convex part 210 of a template 200 is transferred to the resin 320. The template 200 is a plate (print) in order to form a target pattern. Silica glass may be used, for example, in the template 200. The concave and convex part 210 of the template 200 has the transferred shape of the target pattern shape. A release layer 210a may be provided on the top surface of the concave and convex part 210. The concave and convex part 210 of the template 200 is imprinted in the resin 320.

Here, imprinting includes pressing the template 200 onto the substrate W as well as contacting the template 200 to the resin 320.

Next, as illustrated in FIG. 2C, while the concave and convex part 210 of the template 200 is imprinted in the resin 320, ultraviolet light UV is irradiated through, for example, the template 200, to the resin 320. The resin 320 cures by irradiation with ultraviolet light UV.

As illustrated in FIG. 2D, after the resin 320 has cured, the template 200 is released from the pattern 310. In this manner, the pattern 310 of the resin 320 in which the shape of the concave and convex part 210 has transferred, is formed on the substrate W.

Note that a thermosetting resin that cures with the application of heat may also be used in place of an ultraviolet curable resin that cures by light irradiation. In that case, while the template 200 is imprinted in the resin 320, the resin 320 is cured by the application of heat at a prescribed temperature, and after curing, the template 200 is released. In this manner, the shape of the concave and convex part 210 is transferred to the resin 320 to form the pattern 310.

The transfer part 30 repeats the process illustrated in FIGS. 2A to 2D by shifting its position on the substrate W.

In the pattern transfer where the template 200 is used, the target pattern 310 is formed within the range on the substrate W according to the region of the concave and convex part 210 with a one-time process (one cycle of FIGS. 2A to 2D). For example, a concave and convex shape that corresponds to a pattern of a single chip or a plurality of chips of a semiconductor device is provided in the concave and convex part 210 of the template 200. By so doing, the pattern 310 that corresponds to a single chip or a plurality of chips is formed with a one-time process.

The pattern formation device 110 according to the embodiment uses the template 200 such as that described above to form the target pattern 310 by transferring the shape of the concave and convex part 210 to the resin 320 which is one example of a transferring object.

As illustrated in FIG. 1, the calculation part 10 of the pattern formation device 110 uses design information of the pattern 310 to calculate the distribution of force applied to the pattern 310 when releasing the template 200 imprinted in the transferring object from the pattern 310. In other words, the calculation part 10, prior to pattern transfer by the transfer part 30, calculates in advance the distribution of force applied to the pattern 310 at the time of releasing the template 200.

The distribution of force applied to the pattern 310 at the time of releasing the template 200 is the distribution of stress applied to the pattern 310 at the time of release and/or the frictional force that occurs between the pattern 310 and the template 200 at the time of release. In this embodiment, the terms stress and frictional force will be referred to generically as simply “force”.

The calculation part 10 divides the region of the transferring object in contact with, for example, the concave and convex part 210 of the template 200 into a plurality of blocks, and the force is calculated for each block within the plurality of blocks. For example, the plurality of blocks may be provided in a matrix in the region of the transferring object in contact with the concave and convex part 210. The size of each block within the plurality of blocks may be equivalent or different.

The calculation part 10, when calculating the force, may also use design information of the concave and convex part 210 in addition to the design information of the pattern 310.

The calculation part 10 calculates the stress and frictional force for each block within the plurality of blocks as a parameter for at least one of the information that can be understood from the design information of the pattern 310 such as the density of the pattern 310, the perimeter of the pattern 310, the aspect ratio of a cross-section taken in the extending direction of the pattern 310, the shape of the pattern 310, the extending direction of the pattern 310, and the like.

Further, the calculation part 10, in addition to the parameters given above, may calculate the stress and frictional force for each block within the plurality of blocks as a parameter for at least one of the information such as the depth of the concave part (height of the convex part) of the concave and convex part 210, the flatness of the template 200, and the like.

The adjustment part 20 adjusts the forming conditions of the pattern 310 in order to uniformly approach the distribution of force calculated by the calculation part 10.

The adjustment part 20 adjusts at least one of the following as a forming condition of the pattern 310, for example, the composition of the transferring object (for instance, the resin 320), the forming condition onto the substrate W of the transferring object (for instance, the application amount, the application region, or the application location of the resin 320 by the nozzle NZ), the curing conditions of the transferring object (for instance, the amount of ultraviolet light exposure, the irradiation shape, the numerical aperture (NA), the polarized state, the dynamic focus setting, aberration, the development condition, temperature, or post exposure bake (PEB)).

The adjustment part 20 may also adjust the forming conditions of the pattern 310 for each block within the plurality of blocks when a calculation is performed in the calculation part 10 for the force for each block within the plurality of blocks.

The transfer part 30 uses the forming conditions of the pattern 310 adjusted by the adjustment part 20 to transfer the shape of the concave and convex part 210 to the transferring object (for example, the resin 320).

In the pattern formation device 110 according to the embodiment, because the distribution of force is predicted in advance and the parameters that effect the distribution of force are adjusted, the distribution of force applied to the pattern 310 is uniformly approached when actually releasing the template 200 from the pattern 310. Therefore, peeling or collapsing of the pattern 310 that occurs easily at the time of releasing the template 200 can be suppressed. Accordingly, using the pattern formation device 110 improves the yield of pattern formation where the template 200 is used.

Here, various causes of a drop in yield can be observed or predicted at each process step with the pattern formation method in which an imprint of the template 200 is used. Various causes have been considered for the drop in yield. Examples include uneven application of the resin 320, dimensional variance when preparing the template 200, insufficient rinsing of the template 200, and damage to the concave and convex part 210.

Further, other causes may be, for example, a lack of resin 320, an air bubble between the concave and convex part 210 and the resin 320, the template 200 slipping off, or the like, in a step to imprint the template 200. Still, further examples may be uneven irradiation of ultraviolet light, uneven curing of the resin 320, uneven expansion or contraction of the resin 320, or the like, in a step to cure the resin 320 by irradiation of ultraviolet light. Due to these various causes, pattern peeling, pattern collapsing or the like occurs causing a drop in yield when releasing the template 200.

Various process tuning is considered to counter these causes of the drop in yield. For example, ingenuity of material properties of the template 200, adjustments in the material of the resin 320, and ingenuity in the rinsing method of the template 200.

An increase in defects that depend on the shape of the pattern 310 or the arrangement of the pattern 310 can be anticipated in conjunction with the miniaturization of the pattern 310. One example is that the stress distribution at the time of imprinting and at the time of releasing the template 200 differs depending on the density of the pattern 310 and the arrangement of the pattern 310. Therefore, it is considered that failures are brought about in pattern formation in locations where a sudden change in stress occurs.

In the pattern formation device 110 according to the embodiment, the cause of a drop in yield that depends on the shape of the pattern 310 is accurately predicted and adjustment of the process is flexibly carried out according to the pattern 310. Therefore, the defect density in the patterning can be lowered which leads to an increase in yield.

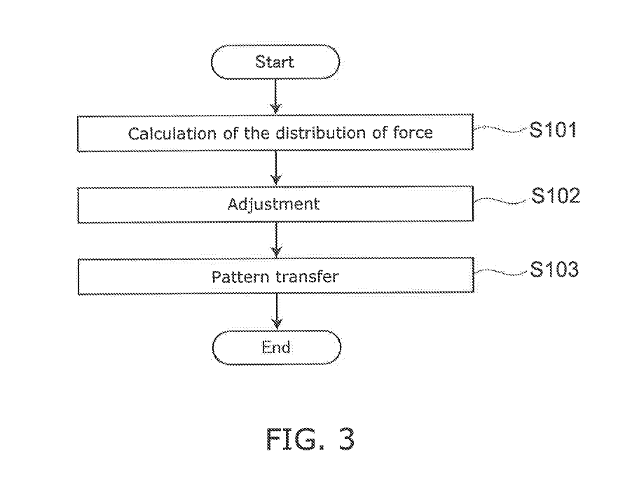

FIG. 3 is a flowchart illustrating an example of a method for pattern formation according to an embodiment.

The method for pattern formation according to the embodiment includes a calculation of the distribution of force (step S101), an adjustment (step S102), and a pattern transfer (step S103). The processes indicated by these steps are performed by, for example, the pattern formation device 110. Note that the process indicated in each step may be performed by a single device or it may be performed by at least two devices.

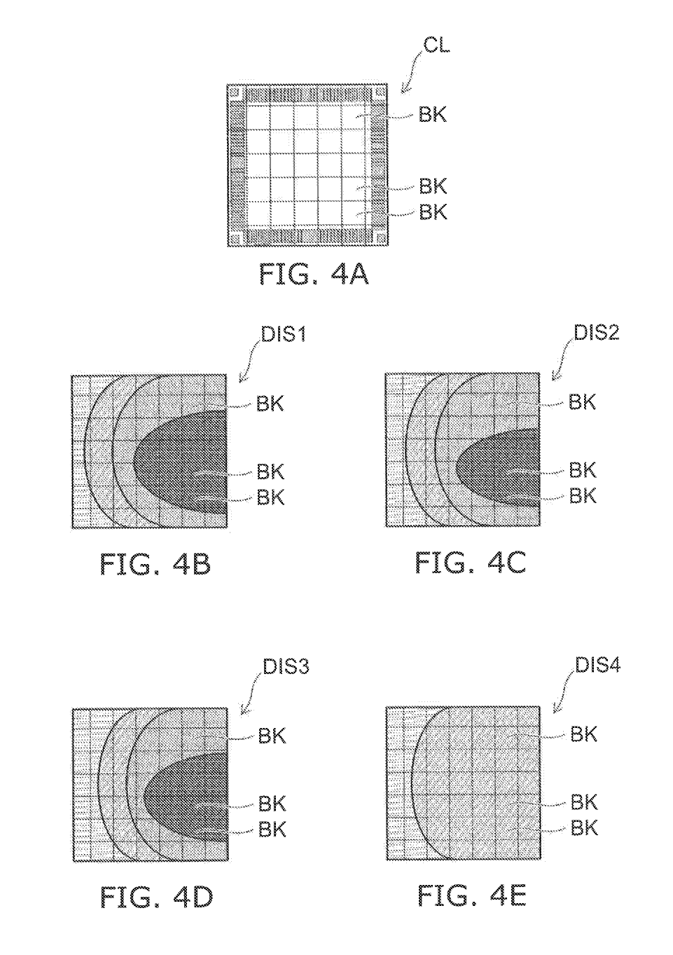

FIGS. 4A to 4E are schematic illustrations to describe the processes from the calculation of the distribution of force to the adjustment.

FIG. 4A illustrates an example of a chip layout. A chip layout CL is a design layout of the pattern 310 formed by the template 200. In the process described in step S101 of FIG. 3, the chip layout CL illustrated in FIG. 4A is divided into a plurality of blocks BK, and the force on each block BK is calculated. Note that the blocks BK illustrated in FIG. 4A are in sizes convenient for the explanation and in actuality are divided into smaller regions. Further, the blocks BK are not limited to a square shape, and the size of each block BK may be equivalent or different.

In the process described in step S101, the distribution of the amount of characteristic relating to pattern arrangement is calculated for each block BK from the chip layout CL. The amount of characteristic is at least one of, for example, the density of the pattern, the perimeter of the pattern, the aspect ratio of a cross-section taken in the extending direction of the pattern, the shape of the pattern, and the extending direction of the pattern. FIG. 4B schematically illustrates a distribution DIS1 in which the amount of characteristic for each block BK is mapped. For example, dotted regions with the same concentration illustrated in FIG. 4B are regions with the same force.

In the process indicated in step S101, the distribution of force at the time of releasing the template 200 is further calculated based on the distribution of this amount of characteristic. The force calculated for each block BK becomes the distribution of force corresponding to the chip layout CL. FIG. 4C schematically illustrates a distribution of force DIS2 at the time of releasing the template 200.

Next, in the process indicated in step S102 of FIG. 3, adjustment amounts are mapped for items to adjust the force required at the time of releasing the template 200. In other words, in the process indicated in step S102, adjustment of the forming conditions of the pattern is executed to uniformly approach the distribution of force calculated in step S101. This adjustment is performed for each block.

The adjustment amount is at least one of the following, for example, the composition of the transferring object (for instance, the resin 320), the forming condition onto the substrate W of the transferring object (for instance, the application amount, the application region, or the application location of the resin 320 by the nozzle NZ), the curing conditions of the transferring object (for instance, the amount of ultraviolet light exposure, the irradiation shape, the numerical aperture (NA), the polarized state, the dynamic focus setting, aberration, the development condition, temperature, or PEB).

The adjustment amount becomes the amount that the force calculated for each block BK is weakened or strengthened. By so doing, the force at the time of releasing the template 200 can be uniformly approached for the entire region where the template 200 contacts the transferring object.

FIG. 4D schematically illustrates a distribution DIS3 in which the adjustment amount for each block BK is mapped. The distribution DIS3 is in a map format according to each adjustment amount.

Next, in the process indicated in step S103 of FIG. 3, transfer of the pattern in which the template 200 was used is performed according to the adjustment amounts found in step S102. FIG. 4E illustrates a distribution of force DIS4 at the time of releasing the template 200 after adjustment. In the distribution DIS4 illustrated in FIG. 4E, the force compared to the distribution DIS1 illustrated in FIG. 4B is uniformly approached.

Here, descriptions are provided of the items that are adjusted in step S102.

First, a description is given of an example of an item for adjusting the forming condition of the pattern 310.

In adjusting the exposure amount of an ultraviolet light or the like irradiated onto the resin 320, a light is irradiated onto the resin 320 based on an exposure amount map of an ultraviolet light or the like for each block BK. By doing this, adjustment is performed of the exposure amount. To adjust the exposure amount, an arrayed light source that can adjust the exposure amount for each block BK may be used.

In adjusting the temperature, the exposure amount of the ultraviolet light or an infrared light irradiated onto the resin 320 is adjusted based on a temperature adjustment map (the distribution DIS3 according to the adjustment amount of the temperature). Or, the temperature is adjusted by using a heater based on the temperature adjustment map. To adjust the temperature, a stage in which a heater that can adjust the temperature for each block BK is incorporated may be used as, for example, a stage that mounts the substrate W.

In adjusting the thickness of the resin 320, the amount of the resin 320 discharged onto the substrate W is adjusted for each block BK.

In adjusting material component of the resin 320, an additive is added after discharging the resin 320 based on an adjustment map of the component of the resin material (the distribution DIS3 according to the adjustment amount of the material component). Or, the component may be adjusted at each discharge of the resin 320 based on the adjustment map of the component of the resin material.

With this type of method for pattern formation, the force applied to the pattern 310 at the time of releasing the template 200 is uniformly approached thereby suppressing peeling and collapsing of the pattern 310. Accordingly, the yield of the pattern formation in which the template 200 is used is improved.

### Second Embodiment

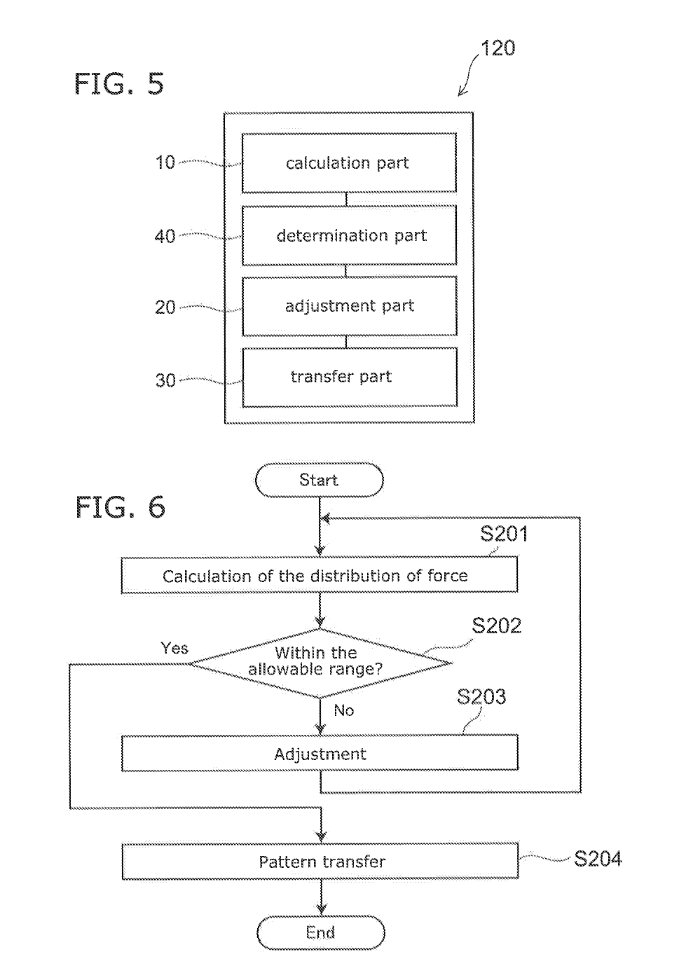

FIG. 5 is a block diagram illustrating an example of a configuration of a pattern formation device according to a second embodiment.

As illustrated in FIG. 5, a pattern formation device 120 according to an embodiment is provided with a calculation part 10, an adjustment part 20, a transfer part 30, and a determination part 40.

In other words, the pattern formation device 120 is further provided with a determination part 40 in the configuration of the pattern formation device 110 illustrated in FIG. 1.

The determination part 40 determines whether the distribution of force calculated by the calculation part 10 is within a preset allowable range.

The adjustment part 20 does not adjust the formation information of the pattern 310 described above when the distribution of force is determined by the determination part 40 to be within the allowable range. On the other hand, the adjustment part 20 adjusts the formation information of the pattern 310 when the distribution of force is determined by the determination part 40 to be outside the allowable range.

FIG. 6 is a flowchart illustrating an example of a method for pattern formation according to an embodiment.

The method for pattern formation according to the embodiment includes a calculation of the distribution of force (step S201), a determination of whether it is within the allowable range (step S202), an adjustment (step S203), and a pattern transfer (step S204). The processes indicated by these steps are performed by, for example, the pattern formation device 120. Note that the process indicated in each step may be performed by a single device or it may be performed by at least two devices.

In the process indicated in step S201, similar to the example illustrated in FIGS. 4A to 4C, the distribution of force DIS2 at the time of releasing the template 200 from the chip layout CL is calculated.

In the process indicated in step S202, it is determined whether the distribution of force DIS2 is within a preset allowable range.

If it is determined in step S202 that it is within the allowable range, then it proceeds to step S204 and the transfer of the pattern using the template 200 is performed without the forming conditions of the pattern 310 being adjusted.

On the other hand, if it is determined in step S202 that it is outside the allowable range, then it proceeds to step S203. In the process indicated in step S203, an adjustment is made to the forming conditions of the pattern 310. The process of step S203 is a similar process to that indicated in step S102 of FIG. 3.

After an adjustment is made in the process of step S203, it returns to step S201 where a calculation of the distribution of force is performed again. When the distribution of force is outside the allowable range, step S203, step S201, and step S202 are repeated. When the distribution of force is within the allowable range, it proceeds to step S204, and transfer of the pattern using the template 200 is performed by the adjusted forming conditions.

With this type of method for pattern formation, because an adjustment is made to the forming conditions of the pattern 310 only when the distribution of force is outside the preset allowable range, it can be done without making unnecessary adjustments. Further, when necessary, pattern transfer using the template 200 can be performed after adjustments. By doing this, the formed pattern 310 can be within the preset allowable range.

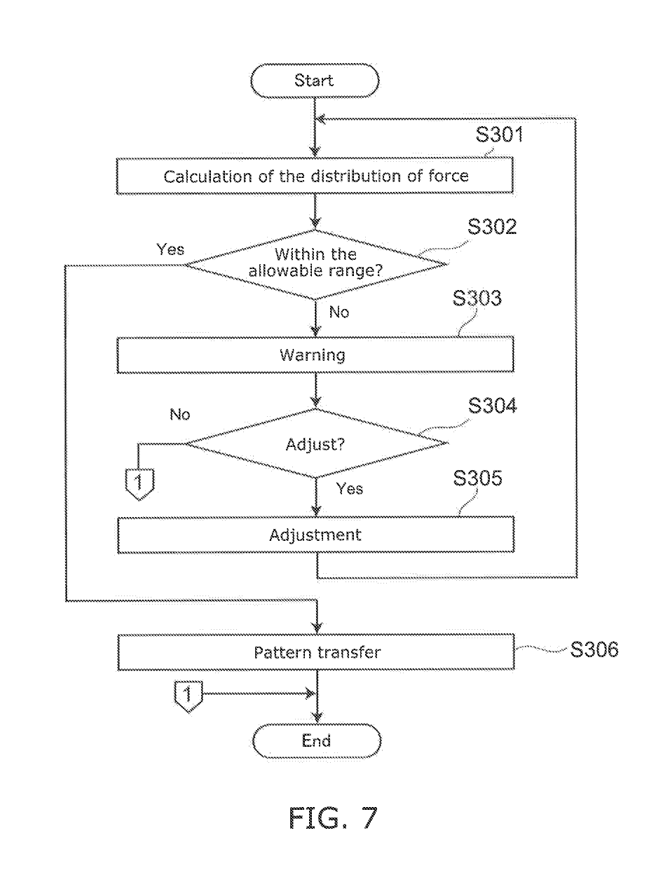

FIG. 7 is a flowchart illustrating another example of a method for pattern formation according to an embodiment.

Another example (1 of such) of a method for pattern formation according to the embodiment includes a calculation of the distribution of force (step S301), a determination of whether it is within the allowable range (step S302), a warning (step S303), a determination of whether to make an adjustment (step S304), an adjustment of the forming conditions or the design information (step S305), and a pattern transfer (step S306). The processes indicated by these steps are performed by, for example, the pattern formation device 120. Note that the process indicated in each step may be performed by a single device or it may be performed by at least two devices.

In the process indicated in step S301, similar to the example illustrated in FIGS. 4A to 4C, the distribution of force DIS2 at the time of releasing the template 200 from the chip layout CL is calculated.

In the process indicated in step S302, it is determined whether the distribution of force is within a preset allowable range. When the distribution of force is determined to be within the allowable range, it proceeds to step S306. On the other hand, when the distribution of force is determined to be outside the allowable range, it proceeds to step S303. In the process indicated in step S303, a warning is issued. The warning is issued by the device (for example, the pattern formation device 120) that performed the process of step S302.

Next, in the process indicated in step S304, it is determined whether to make an adjustment. For example, when an instruction is given to the pattern formation device 120 for a user of the pattern formation device 120 to make an adjustment, it proceeds to step S305 to make the adjustment after receiving this instruction. On the other hand, when an instruction is received that an adjustment is not to be made, or when no instruction has been received after a prescribed time period has elapsed after issuance of a warning, the process is terminated.

In the process indicated in step S306, an adjustment is made to the forming conditions of the pattern 310. After an adjustment is made in the process of step S306, it returns to step S301 where a calculation of the distribution of force is performed again. When the distribution of force is outside the allowable range, step S303, step S304, step S305, step S301, and step S302 are repeated. When the distribution of force is within the allowable range, it proceeds to step S306, and the transfer of the pattern using the template 200 is performed by the adjusted forming conditions.

With this type of method for pattern formation, because a warning is issued when the distribution of force is outside the preset allowable range, an adjustment is made to the forming conditions of the pattern 310 only when an instruction to make an adjustment has been received. By doing this, it can be done without making unnecessary adjustments. Further, when necessary, pattern transfer using the template 200 can be performed after adjustments. The pattern 310 formed by this method can be within the preset allowable range.

Note that in the method for pattern formation illustrated in the flowchart of FIG. 7, after a warning is issued in step S303, a determination is made whether to make an adjustment in step S304, however, the process may also be terminated after issuing the warning.

Although the description given above address procedures for a determination based on the distribution of force, a determination may also be similarly made based on a release amount or deformation amount from a desired pattern for the pattern being formed.

### Third Embodiment

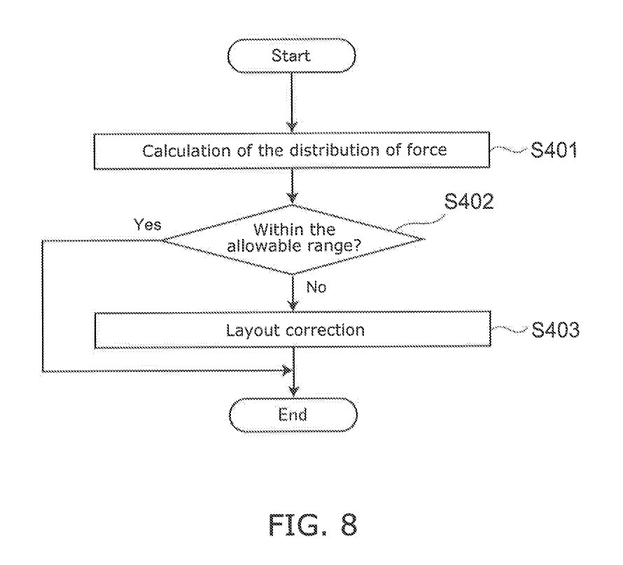

FIG. 8 is a flowchart illustrating an example of a method for pattern formation according to a third embodiment.

The method for pattern formation according to the embodiment includes a calculation of the distribution of force (step S401), a determination of whether it is within an allowable range (step S402), and layout correction (step S403).

In the process indicated in step S401, similar to the example illustrated in FIGS. 4A to 4C, the distribution of force DIS2 at the time of releasing the template 200 from the chip layout CL is calculated.

In the process indicated in step S402, it is determined whether the distribution of force DIS2 is within a preset allowable range.

In step S402, if it is determined to be within the allowable range, it proceeds to formation of the pattern 310 using the template 200 for which the calculation of the distribution of force was made.

On the other hand, if it is determined in step S402 that it is outside the allowable range, then it proceeds to step S403. In the process indicated in step S403, the design information of the pattern 310 is modified. In other words, the layout of the pattern 310 is modified.

Here, a description is given of an example of an item for adjusting the design information of the pattern 310.

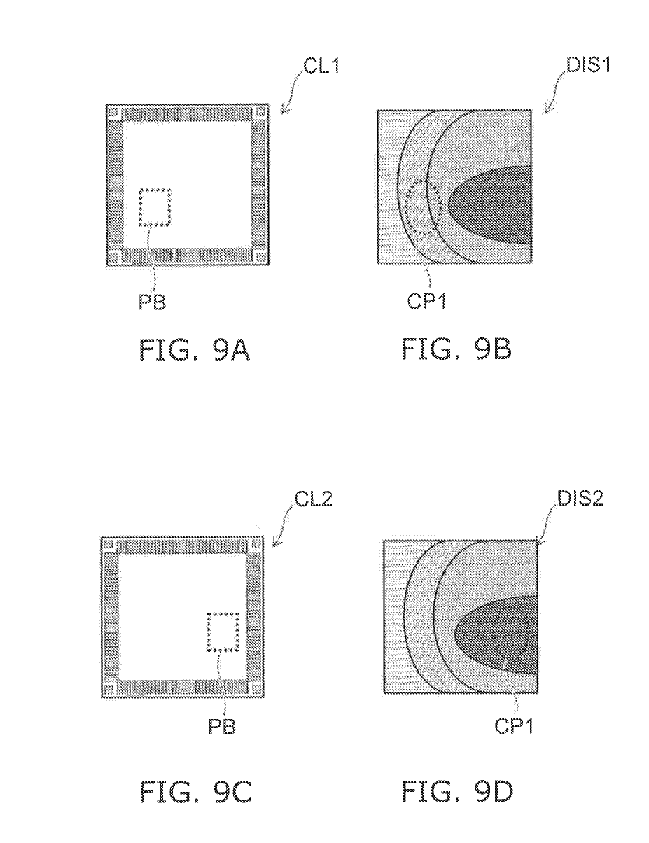

FIGS. 9A to 9D are schematic views illustrating examples of where the position of a pattern block is modified.

A pattern block is a grouped region of a pattern having a prescribed function.

In FIG. 9A, an example of a chip layout CL1 is illustrated. When adjusting design information, first, the position of the pattern block PB1 where high formation accuracy is required from the perspective of circuit importance and the like, is identified within the chip layout CL1.

Next, a location CP1 where the force rapidly changes is identified from the distribution of force DIS2 illustrated in FIG. 9B. In adjusting design information, if the position of the pattern block PB1 is near the location CP1 where the force rapidly changes, then the layout is modified so that the pattern block PB1 is removed from the location CP1 where the force rapidly changes.

In FIG. 9C, an example of a chip layout CL2 after the layout of the pattern block PB1 was modified, is illustrated. With the chip layout CL2, the pattern block PB1 is moved to the location CP2 where the force does not rapidly change in the distribution of force DIS2 illustrated in FIG. 9D.

According to this chip layout CL2, because the pattern block PB1 having, for example, a circuit with high importance, is laid out in a position where there is high uniformity of force at the time of releasing the template 200, the pattern block PB1 can be formed with precision.

For example, as illustrated in FIG. 9A, if the pattern block PB1 is arranged near the location CP1 where the force rapidly changes in the distribution of force DIS2, a degree of pattern deformation can be expected when pattern formation is performed using the template 200 with the chip layout CL1 as is. Furthermore, an effect on device performance may also be expected.

Further, in the process indicated in step S202, it is determined whether the degree of pattern deformation and the effect on device performance are within preset allowable ranges.

The following are examples of determination standards of whether it is within the allowable range.

(1) A region that cannot be relieved by redundancy circuitry, such as a peripheral circuit or a fuse circuit, in a memory device is determined to be outside the allowable range when the defect probability is at least a prescribed value.

(2) A memory device is determined to be outside the allowable range when the defect probability exceeds the relief available through redundancy circuitry.

(3) Circuitry in which dimensional variance, such as a memory cell array in a memory device, has a devastating effect on circuit operation is determined to be outside the allowable range when the dimensional variance exceeds a prescribed range.

(4) Locations such as a critical path in a logic device where strict dimensional precision is required for the characteristics of a circuit are determined to be outside the allowable range when the dimensional variance is at least a prescribed range.

Note that items (1) to (4) are individual examples and determination standards other than these may also be adopted.

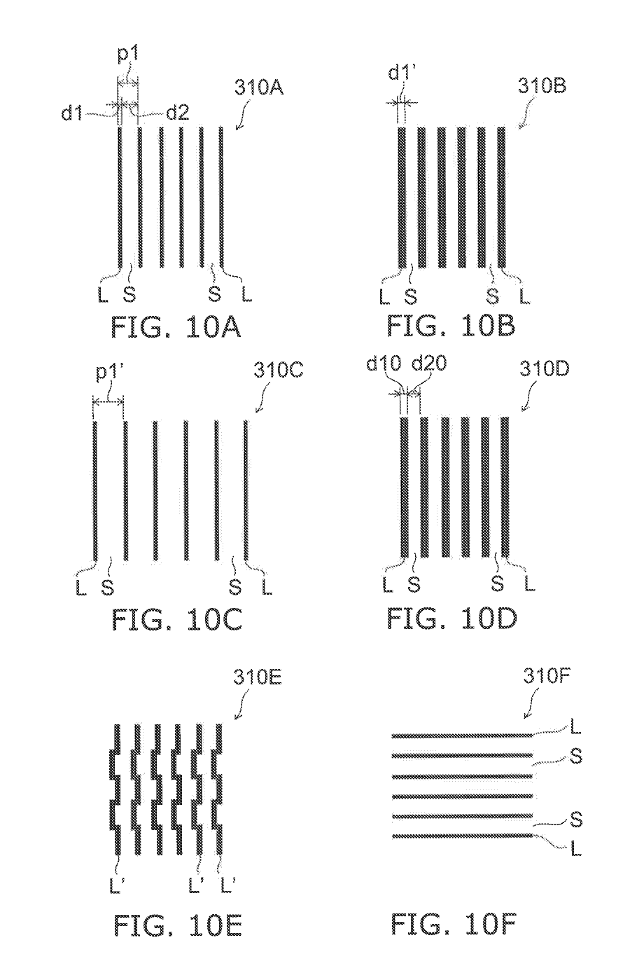

FIGS. 10A to 10F are schematic plan views illustrating examples of pattern correction.

FIG. 10A illustrates an example of a pattern 310A prior to modification. As an example, the pattern 310A has a line L and a space S. In the pattern 310A, the width of the line L is d1, the width of the space S is d2, and the pitch of the line L is p1.

In modifying the design information of the pattern 310A, an objective would be to either modify in order to make the distribution of force uniform or to modify to increase the opposing force of the force applied at the time of releasing the template 200.

In a pattern 310B illustrated in FIG. 10B, the width d1′ of the line L is thicker than the width d1 of the line L of the pattern 310A illustrated in FIG. 10A.

Generally, as the width of the line L becomes thicker, although the definition of the template 200 improves, the strain and deformation that occurs with cure shrinkage of the resin 320 due to irradiation of ultraviolet light UV becomes larger.

In a pattern 310C illustrated in FIG. 10C, the pitch p1′ of the line L is wider than the pitch p1 of the line L of the pattern 310A illustrated in FIG. 10A. The width d1 of the line L is the same.

Generally, as the pitch of the line L becomes wider, the force at the time of releasing the template 200 is eased.

In a pattern 310D illustrated in FIG. 10D, the ratio between the width d10 of the line L and the width d2 of the space S differs from the ratio between the width d1 of the line L and the width d2 of the space S of the pattern 310A illustrated in FIG. 10A.

Generally, definition properties of the pattern 310D and the incidence rate of unfilled defects of the resin 320 or the strain and deformation amount in the line L occurring with cure shrinkage of the resin 320 due to irradiation of ultraviolet light UV change depending on the ratio of the width of the space S to the width of the line L.

In a pattern 310E illustrated in FIG. 10E, the perimeter of the line L′ is longer than the perimeter of the line L of the pattern 310A illustrated in FIG. 10A.

Generally, the longer the perimeter of the line L′, the larger the friction between the template 200 and the pattern L′ thereby increasing the opposing force on the force applied at the time of releasing the template 200.

In the pattern 310F illustrated in FIG. 10F, the extending directions of the line L and the space S are different than the extending directions of the line L and the space S in the pattern 310A illustrated in FIG. 10A.

When releasing the template 200, the separation position between the template 200 and the transferring object may advance in a fixed direction (releasing direction).

Generally, the direction to which stress is applied when releasing the template 200 changes depending on the releasing direction and the extending direction of the pattern 310F as well as on the shape and the size of the pattern 310F.

By adjusting the design information of the pattern 310A in this manner, either a modification is made to make the distribution of force uniform or a modification is made to increase the opposing force of the force applied at the time of releasing the template 200. By doing this, a new template 200 that corresponds to the pattern 310 after design modification can be prepared to perform pattern formation according to this template 200. By doing this, breaks or collapsing of the pattern 310 that occurs easily at the time of releasing the template 200, can be suppressed thereby increasing the yield of the pattern formation.

### Fourth Embodiment

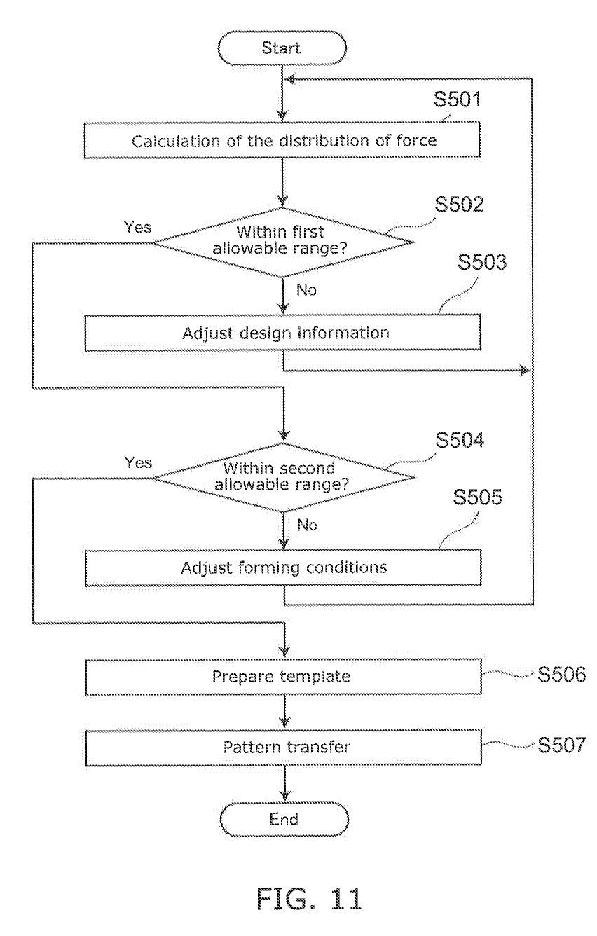

FIG. 11 is a flowchart illustrating an example of a method for pattern formation according to a fourth embodiment.

The method for pattern formation according to the embodiment provides a calculation of the distribution of force (step S501), a determination of whether it is within a first allowable range (step S502), an adjustment of the design information (step S503), a determination of whether it is within a second allowable range (step S504), an adjustment of the forming conditions (step S505), a template preparation (step S506), and a pattern transfer (step S507). The processes indicated by these steps are performed by, for example, the pattern formation device 120.

In the process indicated in step S501, similar to the example illustrated in FIGS. 4A to 4C, the distribution of force DIS2 at the time of releasing the template 200 from the chip layout CL is calculated.

In the process indicated in step S502, it is determined whether the distribution of force is within a preset first allowable range. When the distribution of force is determined to be within the first allowable range, it proceeds to step S504. On the other hand, when the distribution of force is determined to be outside the first allowable range, it proceeds to step S503. In the process indicated in step S503, the design information of the pattern 310 is adjusted.

After an adjustment is made in the process of step S503, it returns to step S501 where a calculation of the distribution of force is performed again. When the distribution of force is outside the first allowable range, step S503, step S501, and step S502 are repeated. When the distribution of force is within the first allowable range, it proceeds to step S504.

In the process indicated in step S504, it is determined whether the distribution of force is within a preset second allowable range. When the distribution of force is determined to be within the second allowable range, it proceeds to step S507. On the other hand, when the distribution of force is determined to be outside the second allowable range, it proceeds to step S505. In the process indicated in step S505, an adjustment is made to the forming conditions of the pattern 310.

After an adjustment is made in the process of step S505, it returns to step S501 where a calculation of the distribution of force is performed again. When the distribution of force is outside the first allowable range, step S503, step S501, and step S502 are repeated. When the distribution of force is outside the second allowable range, step S505, step S501, and step S504 are repeated. When the distribution of force is within both the first allowable range and the second allowable range, it proceeds to step S506.

In the process of step S506, the template 200 is prepared corresponding to the pattern 310 after being adjusted based on the design information of the pattern 310 adjusted in step S503. Next, in the process indicated in step S507, transfer of the pattern using the template 200 is performed according to the forming conditions adjusted in step S505, using the template 200 prepared in step S506.

By this type of method for pattern formation, the design information of the pattern 310 and the forming conditions of the pattern 310 are adjusted so that the distribution of force is within the preset first allowable range and second allowable range. According to this formation method, a highly accurate pattern 310 can be formed with a good yield by adjusting the design information of the pattern 310 and the forming conditions of the pattern 310.

### Fifth Embodiment

Next, a description will be given of a program for pattern information according to an embodiment.

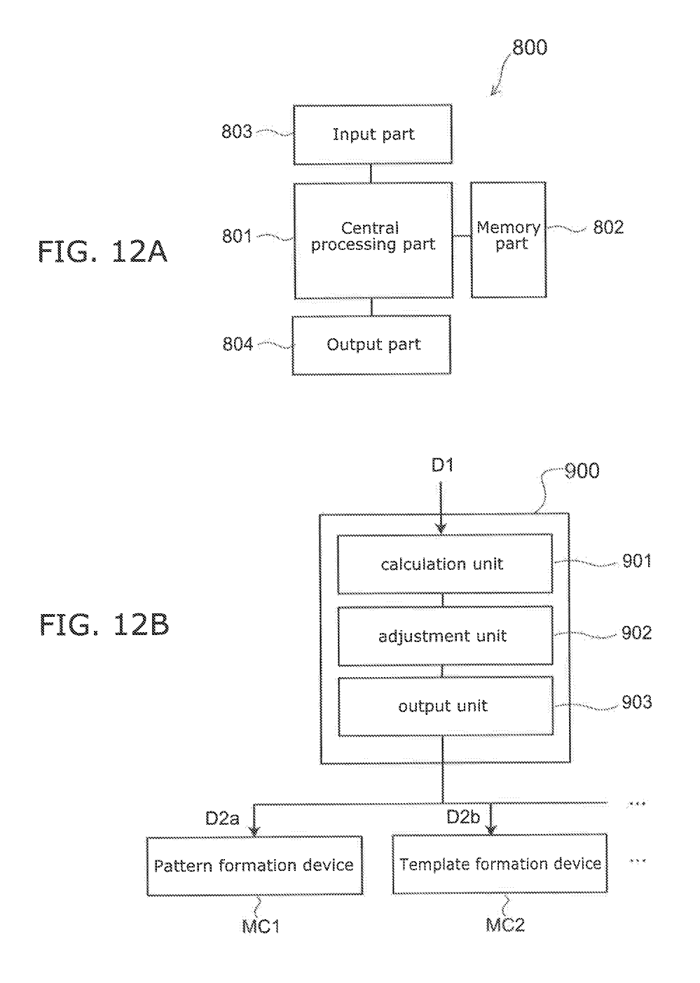

FIGS. 12A and 12B are illustrations to explain a computer on which the program according to the embodiment is executed.

FIG. 12A is a block diagram illustrating a configuration example of a computer.

FIG. 12B is a block diagram to explain the function of a manufacturing program of the template according to the embodiment.

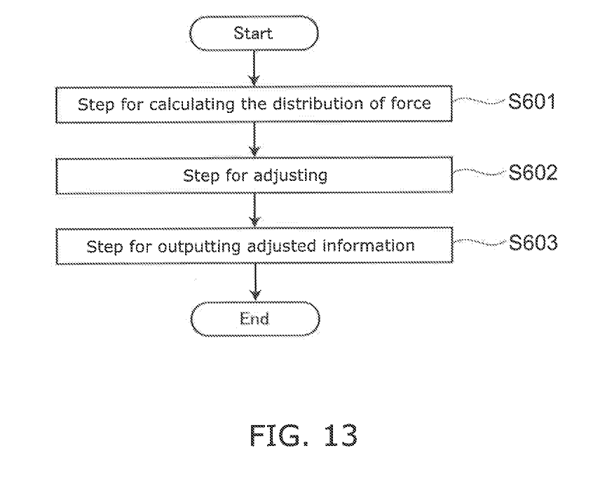

FIG. 13 is a flowchart illustrating an example of a process flow of the program according to the embodiment.

As illustrated in FIG. 12A, a computer 800 is provided with a central processing part 801, a memory part 802, an input part 803, and an output part 804. The central processing part 801 is a part that executes the program for pattern formation according to the embodiment. The memory part 802 includes not only random access memory (RAM) that temporarily stores information such as the program for pattern formation to be executed, but it also includes storage devices such as read only memory (ROM), a hard disk drive (HDD), a semiconductor memory drive, or the like.

The input part 803 includes an interface that inputs information from an external device via a network or the like in addition to a keyboard and a pointing device. The output part 804 includes an interface that outputs information to an external device in addition to a monitor.

As illustrated in FIG. 12B, the program 900 for pattern formation according to the embodiment is what allows the computer 800 (see FIG. 12A) to function as the calculation unit 901, the adjustment unit 902, and the output unit 903. The computer 800 that executes the program 900 for pattern formation functions as, for example, a pattern design support system.

The calculation unit 901 performs the process that calculates the distribution of force applied to the pattern 310 at the time of releasing the template 200 from the transferring object (step S601 of FIG. 13). Specifically, the calculation unit 901 uses the input part 803 of the computer 800 to acquire the parameters D1 necessary to calculate the distribution of force, and calculates, by the central processing part 801, the distribution of force using the acquired parameters D1.

The adjustment unit 902 performs the process that adjusts the forming conditions of the pattern 310 and/or the design information of the pattern 310 in order to uniformly approach the distribution of force calculated by the calculation unit 901 (step S602 of FIG. 13). Specifically, the adjustment unit 902, using the central processing part 801 of the computer 800, adjusts the forming conditions of the pattern 310 and/or the design information of the pattern 310.

The output unit 903 performs the process that outputs externally at least either (information D2a, D2b, . . . ) of the forming conditions of the pattern 310 or the design information of the pattern 310 that has been adjusted by the adjustment unit 902 (step S603 of FIG. 13). Specifically, the output unit 903 outputs the forming conditions (information D2a) of the pattern 310 and/or the design information (D2b) of the pattern 310 adjusted by the central processing part 801 of the computer 800 from the output part 804 of the computer 800 to an external device (a pattern formation device MC1, a template formation device MC2, a database, or another device).

For example, the pattern formation device MC1 performs the transfer of the pattern in which the template 200 was used according to the forming conditions (information D2a) of the pattern 310 that was output from the computer 800. The pattern formation device MC1 includes all types of devices that form a pattern by an imprint method such as a device that applies the resin 320, a device that imprints the template 200, and the like, as well as devices that include at least one of these.

Further, the template formation device MC2 prepares the template 200 by design information (information D2b) of the pattern 310 that was output from the computer 800. Included in the template formation device MC2 are all types of devices that form the template 200 such as an electron beam lithography device, an etching device, and the like, as well as devices that include at least one of these. By performing formation of the pattern according to this template 200, yield is improved.

The program for pattern formation according to the embodiment can be implemented by a mode executed by a computer as described above. Alternatively, the program for pattern formation according to the embodiment can be implemented by a mode stored in a prescribed storage medium. Further, the program for pattern formation according to the embodiment can be implemented by a mode distributed via a network.

As described above, according to the embodiments, a pattern formation device that can form a pattern with a good yield, a method for pattern formation, and a program for pattern formation can be provided.

Note also that although embodiments and variations have been described above, the present invention is not limited to these. For example, configurations of the above described embodiments or variations which have been added to, removed from, or changed in design in a way that could be easily arrived at by a person skilled in the art, and any appropriate combination of the characteristics of the embodiments is to be construed as being within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

1.-11. (canceled)

12. A method for pattern formation that presses a template that includes a concave and convex part onto a transferring object and that forms a pattern in which a shape of the concave and convex part is transferred, comprising:
calculating, using design information of the pattern, a distribution of force applied to the pattern at a time of releasing the template pressed onto the transferring object from the transferring object:
adjusting forming conditions of the pattern in order to uniformly approach the distribution of force; and
transferring the shape of the concave and convex part to the transferring object according to the forming conditions after the adjusting.

13. A method for pattern formation that presses a template that includes a concave and convex part onto a transferring object and that forms a pattern in which a shape of the concave and convex part is transferred, comprising:
calculating, using design information of the pattern, a distribution of force applied to the pattern at a time of releasing the template pressed onto the transferring object from the transferring object;
modifying the design information according to the distribution of force; and
transferring the shape of the concave and convex part to the transferring object according to the modified design information.

14. The method according to claim 12, wherein a distribution of a stress applied to the pattern and/or a frictional force between the pattern and the template is calculated in the process for calculating the distribution of force.

15. The method according to claim 12, wherein a force for each of a plurality of blocks is calculated in the process for calculating the distribution of force by dividing a region of the transferring object where the concave and convex part contacts into the plurality of blocks, and
the forming conditions for each block within the plurality of blocks are adjusted in the process for adjusting the forming conditions.

16. The method according to claim 12, wherein the distribution of force according to the design information of the concave and convex part in addition to design information of the pattern is calculated in the process for calculating the distribution of force.

17. (canceled)
